(19) United States
(12) Patent Application Publication
(10) Pub. No.: US 2014/0347567 A1
(43) Pub. Date: Nov. 27, 2014

(54) DISPLAY DEVICE AND TELEVISION RECEIVER

(71) Applicant: SHARP KABUSHIKI KAISHA, Osaka-shi, Osaka (JP)

(72) Inventors: Kenichiro Ito, Osaka-shi (JP); Hideto Takeuchi, Osaka-shi (JP); Yasufumi Gouma, Osaka-shi (JP)

(21) Appl. No.: 14/371,889

(22) PCT Filed: Sep. 27, 2012
(86) PCT No.: PCT/JP2012/074978

§ 371 Date: Jul. 11, 2014

(30) Foreign Application Priority Data
Jan. 12, 2012 (JP) 2012-004459
Sep. 25, 2012 (JP) 2012-211503

(51) Int. Cl. F21V 15/01; H04N 5/64; F21V 8/00; H04N 9/30

(52) U.S. Cl. CPC F21V 15/01; H04N 9/30; H04N 5/64; G02B 6/0011; G02B 6/0085
USPC 348/791; 362/611

(57) ABSTRACT

A panel guide has a first wall portion standing face to face with a frame, and by the first wall portion having its top in contact with the frame, the panel guide is supported by the frame and forms a space between the panel guide and the frame.

### TECHNICAL FIELD

The present invention relates to a display device and a television receiver.

### BACKGROUND ART

Conventionally, in liquid crystal display devices such as television receivers and monitors for use in personal computers, a configuration has been employed in which a backlight panel (light guide plate) is placed at the back of a display panel with a backlight source placed to a side part of the backlight panel and in which the rear side of the display panel is illuminated by backlight having entered through the side part of the backlight panel. Such a display device can have its casing thinned, as it has no backlight source at the back of the display panel.

In various types of display device as typified by such a display device, there has been increased need for lighter weight, smaller thickness, and reduction in the amount of space that is occupied by a picture frame (referred to also as “bezel”). Furthermore, there is also an issue with heat dissipation measures along with the reduction in thickness. For this reason, in various types of display device, front panels made of metal such as aluminum are starting to be employed. For example, Patent Literature 1, listed below, describes a display device in which a combination of a front frame body and a front panel made of a thermally-conductive aluminum material and surface-coupled to the front frame body is used to cause heat generated by the display device to be dissipated through the front panel. As just described, front panels made of metal not only can easily sustain the rigidity of display devices even in the face of reduction in thickness, but also are superior in heat dissipation property to resin front panels that have conventionally been in heavy usage.

### CITATION LIST

Patent Literature 1

Japanese Patent Application Publication, Tokukai, No. 2005-114851 A (Publication Date: Apr. 28, 2005)

### SUMMARY OF INVENTION

### Technical Problem

However, since the front surface of a display device serves as a surface that faces a viewer, it has a high chance of being touched by the viewer, and actively causing the heat produced in the display device to be dissipated through such a place poses a higher risk of trouble such as getting the user burned. Therefore, the technology described in Patent Literature 1 cannot be said to be a technology that can appropriately dissipate heat generated in a display device.

The present invention has been made in view of the foregoing problems, and it is an object of the present invention to provide a display device that can appropriately dissipate heat of a backlight source.

### Solution to Problem

In order to solve the foregoing problems, a display device according to the present invention includes: a display panel; a backlight panel that guides backlight from a back surface of the display panel to the display panel; a backlight source that illuminates an inner part of the backlight panel with the backlight; a frame that supports the display panel by a front surface side of the display panel; a backlight chassis that supports the backlight panel by a back surface side of the backlight panel; a heat dissipation plate in contact with a substrate of the backlight source and the backlight chassis, for dissipating heat of the backlight source to the backlight chassis; and a panel guide, sandwiched between the frame and the backlight chassis, which supports the display panel, the panel guide having a first wall portion standing face to face with the frame, and by the first wall portion having its top in contact with the frame, the panel guide being supported by the frame and forming a space between the panel guide and the frame.

### Advantageous Effects of Invention

The present invention makes it difficult for the heat generated by the backlight source to be transmitted to the front surface side of the display device and makes it easy for the heat to be dissipate on the back surface side of the display device, thus making it possible to suppress a rise in temperature of the front surface of the display device. This makes it possible to appropriately dissipate the heat generated by the backlight source.

### BRIEF DESCRIPTION OF DRAWINGS

FIG. 1 is an exploded perspective view schematically showing a configuration of a display device according to an embodiment of the present invention.

FIG. 2 is a cross-sectional view showing an internal structure of the display device according to the present embodiment.

FIG. 3 is a cross-sectional view showing the internal structure of the display device according to the present embodiment.

FIG. 4 is a partially-enlarged perspective view of (the back surface side of) the display device according to the

FIG. 5 is an A-A perspective cross-sectional view showing a first cross-sectional structure of the display device shown in FIG. 4.

FIG. 6 is a B-B perspective cross-sectional view showing a second cross-sectional structure of the display device shown in FIG. 4.

FIG. 7 is a C-C perspective cross-sectional view showing a third cross-sectional structure of the display device shown in FIG. 4.

FIG. 8 shows the flow of heat produced in an LED substrate of a display device according to the present embodiment.

FIG. 9 is a diagram schematically showing fastening positions in a display device according to the present embodiment where a frame and a backlight chassis are fastened together.

FIG. 10 is a diagram schematically showing locations of measurement in a display device according to the present example.

FIG. 11 is a graph showing results of measurement of display devices (display devices (1) and (2)) according to the present example.

### DESCRIPTION OF EMBODIMENTS

### Embodiments

An embodiment of the present invention is described below with reference to the drawings.

(Configuration of a Display Device 10 as Schematically Described)

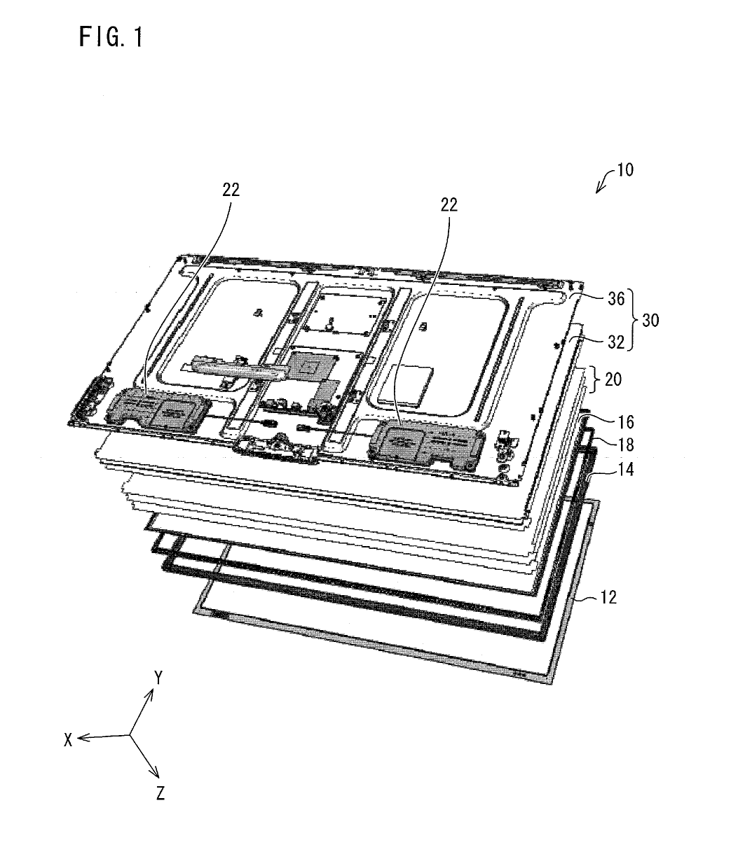

First, a configuration of a display device 10 according to the present embodiment is schematically described with reference to FIG. 1. FIG. 1 is an exploded perspective view schematically showing a configuration of a display device 10 according to an embodiment of the present invention. In particular, FIG. 1 shows the configuration of the display device 10 as viewed from the back surface side. In the description that follows, it is assumed that the display device 10 has its front side (i.e. the side where the picture appears; sometimes referred to also as “front surface side”) facing the region in the drawings in which the z coordinate is positive and the display device 10 has its rear side (sometimes referred to also as “back surface side”) facing the region in the drawings in which the z coordinate is negative.

The display device 10 shown in FIG. 1 is a so-called television receiver which includes a tuner (not illustrated) and a display and which, by replaying content received by the tuner and by causing the display to display the picture represented by the content, allows a user to view the content.

As shown in FIG. 1, the display device 10 includes a bezel 12, a frame 14, a display panel 16, a panel guide 18, optical sheets 20, and a backlight unit 30. In actuality, the display device 10 includes another component, for example a back cover that protects the back surface of the display device 10. However, such a component is not illustrated or described here.

The bezel 12 is attached to the front surface of the frame 14. The bezel 12 is provided for protecting the surface of the frame 14 and improving the appearance of the display device 10. The bezel 12 used here is one made of metal such as aluminum, but a bezel made of a non-metallic material such as resin may be used instead.

The frame 14 supports the display panel 16. Specifically, the frame 14 has a frame part having an opening at the front that corresponds in size to the display region of the display panel 16, and it is this frame part that supports the outer edge of the display panel 16 (i.e. the part of the display panel 16 that is outside of the display region). The frame 14 used here is one made of metal such as aluminum.

The display panel 16 is a so-called liquid crystal display panel which includes a glass substrate, a plurality of TFT (thin-film transistor) liquid crystal pixels formed on the glass substrate, a color filter, a polarization filter, etc. In this display panel 16, a display drive circuit (not illustrated) causes a data signal corresponding to a picture signal to be written to each TFT liquid crystal pixel. This causes the amount of backlight that is transmitted through each TFT liquid crystal pixel to be adjusted in the display panel 16, whereby a picture corresponding to the picture signal is displayed.

The panel guide 18 is fitted onto the rear side of the frame 14. The panel guide 18 supports the display panel 16 so that the display panel 16 is supported in a predetermined place on the inner side of the frame 14. The panel guide 18 used here is one made of a non-metallic material such as resin.

The optical sheets 20 are provided in such a manner as to be sandwiched between the display panel 16 and a backlight panel 32. These optical sheets 20 are provided for adjusting the properties of backlight that enters the liquid crystal display panel 2. For example, the optical sheets 20 include a plurality of sheet-like optical members such as a diffusion panel, a diffusion sheet, a lens sheet, and a polarization reflective sheet.

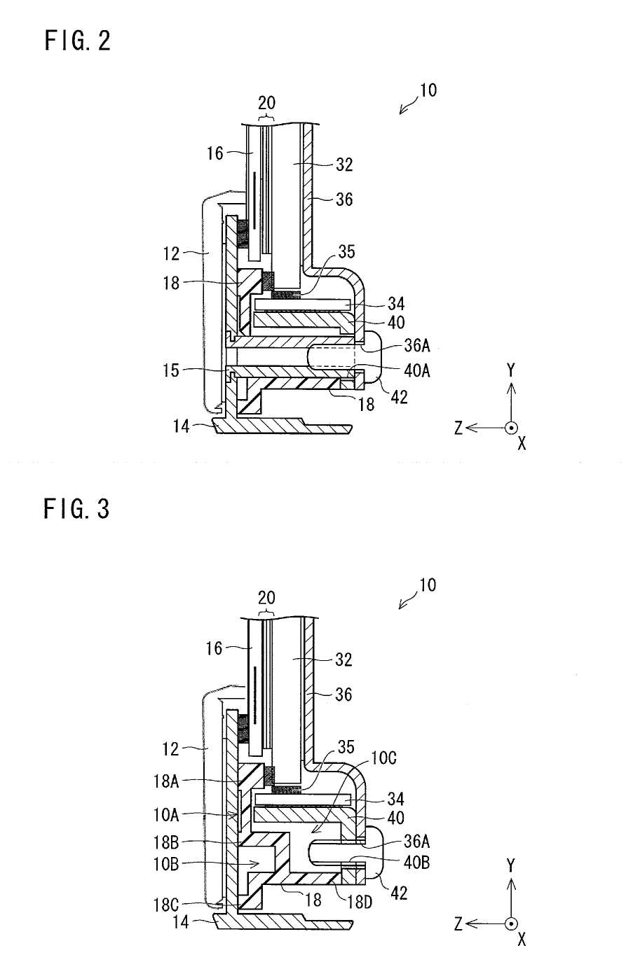

The backlight unit 30, provided at the back of the display panel 16, makes backlight shine on the display panel 16. Specifically, the backlight unit 30 includes the backlight panel 32, an LED substrate 34 (see FIG. 2), and a backlight chassis 36.

The backlight panel 32 is provided at the back of the display panel 16. This backlight panel 32 is a so-called light guide plate that causes backlight having entered the backlight panel 32 through a side part thereof to be guided to the display panel 16.

The backlight chassis 36 supports the backlight panel 32 by the back surface side of the backlight panel 32. The backlight chassis 36 used here is one made of metal such as aluminum. The display device 10 of the present embodiment has a pair of speakers 22 so installed on the back surface of the backlight chassis 36 as to be symmetrically arranged along a long side of the backlight chassis 36. In particular, the speakers 22 employed here are wafer-thin speakers, and as such, do not obstruct reduction in thickness of the body of the display device 10.

The LED substrate 34 includes an LED array 35 (see FIG. 2) serving as a light source and a LED drive circuit (not illustrated) that drives the LED array 35. The LED substrate 34 is provided to a side part of the backlight panel 32, and backlight enters the backlight panel 32 through this side part. In the present embodiment, the LED substrate 34 is provided to the lower side part of the backlight panel 32 (which faces the region in the drawings in which the y coordinate is negative). However, this does not imply any limitation.

Next, an internal configuration of the display device 10 according to the present embodiment is described in concrete terms with reference to FIGS. 2 and 3. FIGS. 2 and 3 are cross-sectional views showing an internal structure of the display device 10 according to the present embodiment. In particular, FIGS. 2 and 3 show the internal configuration of the display device 10 as viewed from the right side (which faces the region in the drawings in which the x coordinate is positive) of the lower part of a cross-section of the display device 10 at a fastening position on a long side (i.e. across the breadth) of the display device 10.

(Internal Configuration in Positions of Fastening to the Frame 14)

In the display device 10 of the present embodiment, the backlight chassis 36 is fastened to the frame 14 by screws 24 at a plurality of fastening positions on a long side of the backlight chassis 36. FIG. 2 shows an internal configuration of a cross-section at one of the fastening positions.

In the display device 10, as shown in FIG. 2, the display panel 16, the optical sheets 20, and the backlight panel 32 are joined on top of each other in the order from the front surface side of the display device 10. Moreover, the display panel 16 is supported by the frame 14 on the front surface side of the display panel 16, and the backlight panel 32 is supported by the backlight chassis 36 on the back surface side of the backlight panel 32. That is, the display panel 16, the optical sheets 20, and the backlight panel 32, which are joined on top of each other, are sandwiched between the frame 14 and the backlight chassis 36.

Provided below the backlight panel 32 is the LED array 35 for causing backlight to enter the backlight panel 32. The LED array 35 is provided on the LED substrate 34. Further provided on the lower side of the LED substrate 34 (which faces the region in the drawings in which the y coordinate is negative) is a heat dissipation plate 40 for dissipating heat of the LED array 35 mainly to the backlight chassis 36.

At each of the fastening positions, there is a boss 15 fixedly provided on a side of the frame 14 that faces the backlight chassis 36. The boss 15 has a length that is substantially equal to a predefined distance between the frame 14 and the backlight chassis 36 so that its top comes into contact with the backlight chassis 36 at the time of assembly of the display device 10.

Formed in a position on the backlight chassis 36 that faces the boss 15 is a hole 36A through which a screw 42 is put. At the time of assembly of the display device 10, the screws 42 are put through the respective holes 36A and screwed shut to the respective bosses 15, whereby the backlight chassis 36 becomes fastened to the frame 14 as shown in FIG. 2 in contact with the respective tops of the bosses 15. In this example, the bosses 15 are fixed to the frame 14 by caulking. However, the way in which the bosses 15 are fixed is not limited to caulking. For example, the bosses 15 may be fixed by welding or press fitting.

In the lower part of the frame 14, the plurality of bosses 15 are placed at certain intervals along a long side (i.e. across the breadth) of the frame 14. Accordingly, in those positions on the backlight chassis 36 which face the respective bosses 15, the holes 36A, through which the screws 42 are put, are placed along a long side (i.e. across the breadth) of the backlight chassis 36.

At the time of assembly of the display device 10, the screws 42 are put through the holes 36A in the plurality of fastening positions, respectively, and the screws 42 are tightened to the bosses 15, respectively. This causes the backlight chassis 36 to be surely coupled to the frame 14 at the plurality of fastening positions. It should be noted that FIG. 2 shows an internal configuration of a cross-section at one fastening position, and the same is equally true of an internal configuration of a cross-section at another fastening position.

(Heat Dissipation Plate 40)

Now, the heat dissipation plate 40 is described in concrete terms. The heat dissipation plate 40 has an upper side wall portion and a rear side wall portion (third wall portion). The upper side wall portion is parallel to the LED substrate 34, and the rear side wall portion is parallel to the backlight chassis 36 and perpendicular to the upper side wall portion. The upper side wall portion of the heat dissipation plate 40 and the LED substrate 34 overlap each other. That is, the upper side wall portion of the heat dissipation plate 40 and the LED substrate 34 are in surface contact with each other. Further, the rear side wall portion of the heat dissipation plate 40 and the backlight chassis 36 overlap each other. That is, the the rear side wall portion of the heat dissipation plate 40 and the backlight chassis 36 are in surface contact with each other.

That is, the heat dissipation plate 40 has a comparatively large area of contact with the LED substrate 34 and the backlight chassis 36. This allows the heat dissipation plate 40 to efficiently dissipate heat produced in the LED array 35 to the backlight chassis 36.

The rear side wall portion of the heat dissipation plate has through-holes 40A, provided in positions that correspond to the bosses 15, through which the bosses 15 are put. The inner diameter of each of these through-holes 40A is slightly larger than the outer diameter of each of the bosses 15. Meanwhile, the inner diameter of each of the holes 36A formed in the backlight chassis 36 is slightly smaller than the outer diameter of each of the bosses 15.

Therefore, after the assembly of the display device 10, the backlight chassis 36 is tightened by the screws 42 with the bosses 15 in contact with the backlight chassis 36 while passing through the through-hole 40A in such a manner as not to make internal contact with the through-holes 40A.

This configuration causes an air layer to be formed between each of the bosses 15 and the heat dissipation plate 40 so that the heat transmitted from the LED array 35 to the heat dissipation plate 40 is not directly transmitted to the bosses 15. Since the screws 42, which fasten the bosses 15 and the backlight chassis 36 together, are made of metal, the heat transmitted through the heat dissipation plate 40 to the backlight chassis 36 is moderately transmitted through the screws 42 to the bosses 15. Furthermore, since the bosses 15 are made of metal, too, the heat transmitted to the bosses 15 is moderately transmitted to the frame 14.

(Internal Configuration in Positions of Fastening to the Heat Dissipation Plate 40)

The backlight chassis 36 is further fastened to the heat dissipation plate 40 by the screws 42 at the plurality of fastening positions on a long side of the backlight chassis 36. FIG. 3 shows an internal configuration of a cross-section at one of the fastening positions.

In these fastening positions, the rear side wall portion of the heat dissipation plate 40 has screw holes 40B formed. The backlight chassis 36 has holes 36A, formed in positions that face the screw holes 40B, through which the screws 42 are put. At the time of assembly of the display device 10, the screws 42 are put through the holes 36A, and the screws 42 are tightened to the screw holes 40B. This causes the backlight chassis 36 and the heat dissipation plate 40 to be coupled in such a state as to overlap each other as shown in FIG. 3.

The heat dissipation plate 40 is provided with the plurality of screw holes 40B placed at certain intervals along a long side (i.e. across the breadth) of the heat dissipation plate 40. Accordingly, in those positions on the backlight chassis 36 which face the respective screw holes 40B, the holes 36A, through which the screws 42 are put, are placed along a long side (i.e. across the breadth) of the backlight chassis 36.

At the time of assembly of the display device 10, the screws 42 are put through the holes 36A at the plurality of fastening positions, respectively, and the screws 42 are tightened to the screw holes 40B, respectively. This causes the backlight chassis 36 and the heat dissipation plate 40 to be surely coupled to each other at the plurality of fastening positions. It should be noted that FIG. 3 shows an internal configuration of a cross-section at one fastening position, and the same is equally true of an internal configuration of a cross-section at another fastening position.

(Panel Guide)

Now, a configuration of the panel guide 18 is described in concrete terms with reference to FIG. 3. The panel guide 18 is configured not only to support the display panel 16 but also to prevent heat produced in the LED substrate 34 from being transmitted to the frame 14.

Specifically, the panel guide 18 has wall portions 18A to C (first wall portions) standing face to face with a front side wall portion of the frame 14. After the assembly of the display device 10, each of the wall portions 18A to C has its top in contact substantially perpendicularly to the back surface of the front side wall portion of the frame 14. This causes an internal space to be formed between the panel guide 18 and the frame 14 as shown in FIG. 3.

For example, in the example shown in FIG. 3, there is an internal space 10A formed between the panel guide 18 and the frame 14 and interposed between the wall portion 18A thereabove and the wall portion 18B therebelow, and there is also an internal space 10B formed between the panel guide 18 and the frame 14 and interposed between the wall portion 18B thereabove and the wall portion 18C therebelow.

Since the panel guide 18 is made of a lowly thermally-conductive resin, the panel guide 18 makes it difficult for the heat produced in the LED substrate 34 to be transmitted to the frame 14. In addition, since the panel guide 18 is configured to be brought into intermittent line contact (point contact in the cross-sectional view) with the frame 14 along the x axis by the top of each of the wall portions 18A to C, which have small areas of contact, the panel guide 18 makes it more difficult for the heat produced in the LED substrate 34 to be transmitted to the frame 14. Furthermore, the internal spaces 10A and 10B formed between the panel guide 18 and the frame 14 function as air layers to exhibit a heat insulation effect that makes it even more difficult for the heat produced in the LED substrate 34 to be transmitted to the frame 14.

Furthermore, the panel guide 18 is also configured to form the internal space 10A by making contact with the frame 14 so that the internal spaces 10A and 10B are closed tightly. This prevents the air from convecting in the internal spaces 10A and 10B, thus enhancing the thermal insulating effect of the panel guide 18.

Further, the panel guide 18 has a wall portion 18D (second wall portion) standing face to face with the rear side wall portion of the backlight chassis 36. After the assembly of the display device 10, the wall portion 18D has its top in contact substantially perpendicularly to the back surface of the rear side wall portion of the backlight chassis 36. This causes an internal space to be formed between the panel guide 18 and the frame 14 as shown in FIG. 3.

In the example shown in FIG. 3, since the heat dissipation plate 40 lies on the back surface of the backlight chassis 36, the wall portion 18D makes contact with the back surface of the rear side wall portion of the heat dissipation plate 40, whereby an internal space 10C interposed between the wall portion 18D thereabove and the upper side wall portion of the heat dissipation plate therebelow is formed between the panel guide 18 and the backlight chassis 36.

Thus, since the panel guide 18 is configured to be brought into intermittent line contact (point contact in the cross-sectional view) with the backlight chassis 36 along the x axis by the top of the wall portion 18D, which has a small area of contact, the panel guide 18 makes it more difficult for the heat produced in the LED substrate 34 to be transmitted to the backlight chassis 36. Furthermore, the internal space 10C formed between the panel guide 18 and the backlight chassis 36 functions as an air layer to exhibit a heat insulation effect that makes it even more difficult for the heat produced in the LED substrate 34 to be transmitted to the backlight chassis 36.

As described above, the use of the panel guide 18 made of resin, the prevention of direct contact between the heat dissipation plate 40 and the bosses 15, and the provision of the panel guide 18 with the wall portions 18A to D allows the display device 10 of the present embodiment to make it difficult for the heat produced in the LED array 35 to be transmitted to the frame 14. This allows most of the heat produced in the LED array 35 to be transmitted to the backlight chassis 36. For this reason, the display device 10 of the present embodiment can be said to be able to efficiently dissipate the heat produced in the LED array 35 to the backlight chassis 36.

In this example, the panel guide 18 has three first wall portions and one second wall portions. However, the present invention is not to be limited to this. As long as the panel guide 18 has one or more wall portions, the present invention can accomplish its goal.

(Internal Configuration in Non-Fastening Positions)

An internal configuration of the display device 10 at non-fastening positions (positions other than those fastening positions shown in FIGS. 2 and 3) on a long side of the display device 10 is substantially the same as that in the fastening positions shown in FIG. 3, but differ from that in the fastening positions shown in FIG. 3 in that a screw 42 is not provided, that the heat dissipation plate 40 is not provided with a through-hole 40A, and that the backlight chassis 36 is not provided with a hole 36A. However, a configuration of the panel guide 18 at the non-fastening positions is the same as that shown in FIG. 3. This makes it possible to bring about an effect of “making it difficult for the heat produced in the LED array 35 to be transmitted to the frame 14” at the non-fastening positions, as in the case of the fastening positions shown in FIG. 3.

(Further Description of the Configuration and Action of the Display Device 10)

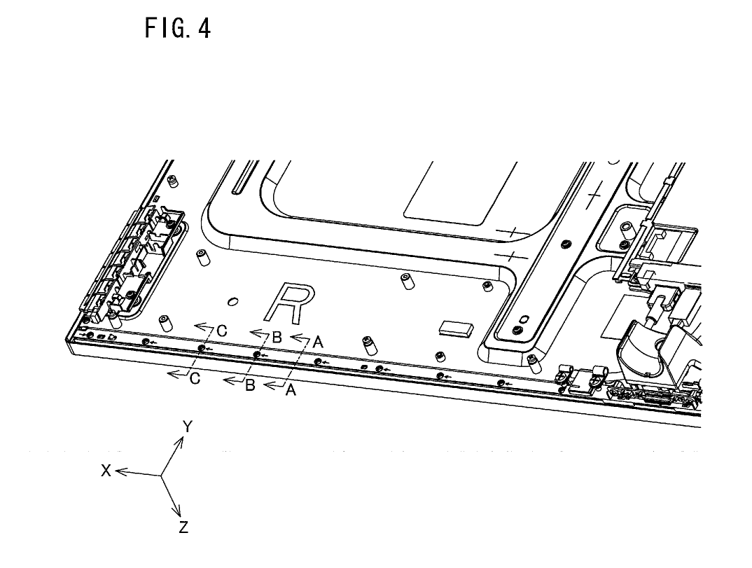

The configuration and action of the display device 10 according to the present embodiment are further described with reference to FIGS. 4 through 8.

FIG. 4 is a partially-enlarged perspective view of (the back surface side of) the display device 10 according to the present embodiment. The display device 10 has any of the following cross-sectional structures at the lower edge thereof:

(1) First cross-sectional structure: There is no fastening by the screws 42.

(2) Second cross-sectional structure: The backlight chassis 36 is fastened to the frame 14 (bosses 15) by the screws 42.

(3) Third cross-sectional structure: The backlight chassis 36 is fastened to the heat dissipation plate 40 by the screws 42.

For example, at the lower edge of the display device 10 as shown in FIG. 4, those portions indicated by the A-A section line, the B-B section line, and the C-C section line have the first, second, and third cross-sectional structures, respectively.

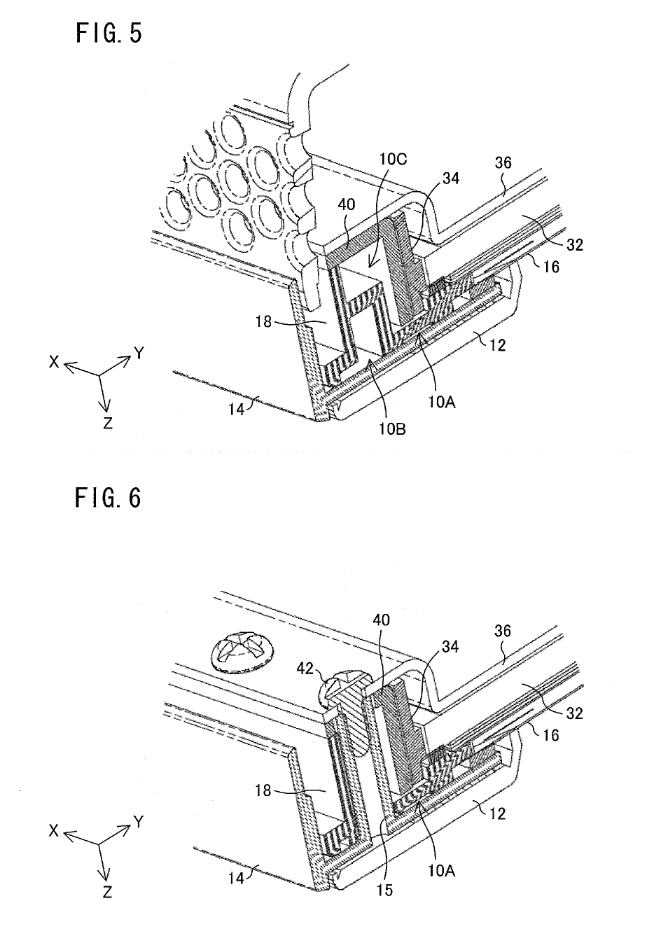

These cross-sectional structures are described below in concrete terms with reference to FIGS. 5 through 7, respectively.

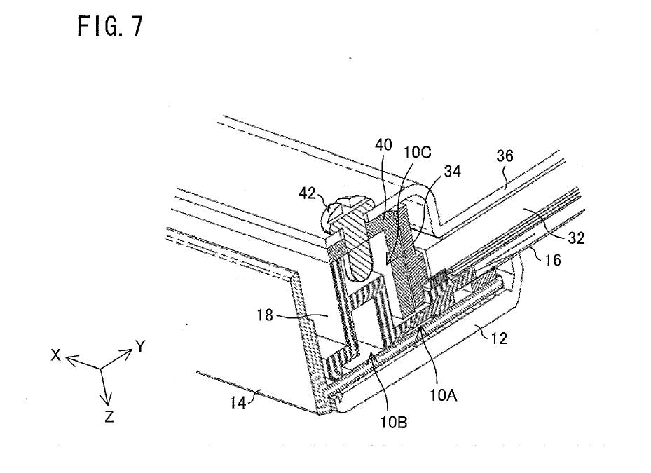

FIG. 5 is an A-A perspective cross-sectional view of a first cross-sectional structure of the display device 10 shown in FIG. 4. FIG. 6 is a B-B perspective cross-sectional view of a second cross-sectional structure of the display device 10 shown in FIG. 4. FIG. 7 is a C-C perspective cross-sectional view of a third cross-sectional structure of the display device 10 shown in FIG. 4.

As shown in FIGS. 5 through 7, at the lower edge of the display device 10, the LED substrate 34, the heat dissipation plate 40, and the panel guide 18 are sandwiched between the frame 14 provided on the front surface side and the backlight chassis 36 provided on the back surface side. In particular, at the lower edge of the display device 10, the cross-sections share the following contrivances in common so that most of the heat transmitted from the LED substrate 34 to the heat dissipation plate 40 is transmitted to the backlight chassis 36.

(Contrivance 1)

As shown in FIGS. 5 through 7, in any of the cross-sections of the display device 10, the heat dissipation plate 40 is in surface contact with the backlight chassis 36 but is in line contact with the panel guide 18. This configuration causes an increase in thermal resistance of the portion of contact with the panel guide 18. Therefore, the heat transmitted from the LED substrate 34 to the heat dissipation plate 40 is easily transmitted to the backlight chassis 36 (i.e. to the back surface side of the display device 10).

(Contrivance 2)

Further, in any of the cross-sections of the display device 10, there is an air layer 10C formed between the heat dissipation plate 40 and the panel guide 18 (excluding those portions of the heat dissipation plate 40 and the panel guide 18 which are in contact with each other). This configuration makes it difficult for the heat transmitted from the LED substrate 34 to the heat dissipation plate 40 to be transmitted to the panel guide 18 from portions other than those portions of the heat dissipation plate 40 which are in contact with the panel guide 18.

(Contrivance 3)

Further, in any of the cross-sections of the display device 10, the panel guide 18 is in line contact with the frame 14. This configuration makes it difficult for the slight amount of heat transmitted from the heat dissipation plate 40 to the panel guide 18 to be transmitted to the frame 14.

(Contrivance 4)

Further, in any of the cross-sections of the display device 10, there are air layers 10A and 10B formed between the panel guide 18 and the frame 14 (excluding those portions of the panel guide 18 and the frame 14 which are in contact with each other). This configuration makes it difficult for the slight amount of heat transmitted from the heat dissipation plate 40 to the panel guide 18 to be transmitted to the frame 14 from portions other than those portions of the panel guide 18 which are in contact with the frame 14.

(Contrivance 5)

In particular, in the second cross-sectional structure (FIG. 6), a boss 15 passes through the heat dissipation plate 40, and in the passage, there is an air layer formed between the boss 15 and the heat dissipation plate 40 so that they do not make contact with each other. This configuration prevents the heat transmitted from the LED substrate 34 to the heat dissipation plate 40 from being transmitted directly to the boss 15 made of metal.

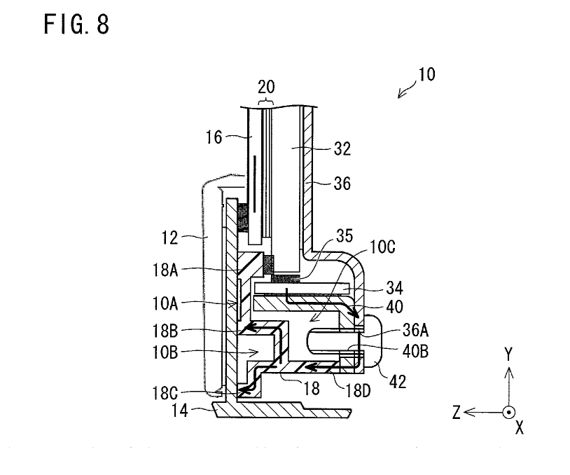

FIG. 8 shows the flow of heat generated in the LED substrate 34 of the display device 10 according to the present embodiment. The flow of heat produced in the LED substrate 34 is described here by using, as a typical example, a cross-section having the third cross-sectional structure (see FIG. 7); however, the same applies to other cross-sections (a cross-section having the first cross-sectional structure and a cross-section having the third cross-sectional structure).

In FIG. 8, the flow of heat produced in the LED substrate 34 is indicated by thick arrows.

(1) The heat produced in the LED substrate 34 is transmitted to the heat dissipation plate 40, which is in surface contact with the LED substrate 34.
(2) Most of the heat transmitted to the heat dissipation plate 40 is transmitted to the backlight chassis 36 (i.e. to the back surface side of the display device 10) which is in surface contact with the heat dissipation plate 40, and furthermore, part of the heat is dissipated from the backlight chassis 36.
(3) Part of the heat transmitted to the heat dissipation plate 40 is transmitted to the panel guide 18, which is in contact with the heat dissipation plate 40. However, since the panel guide 18 and the heat dissipation plate 40 is in line contact with each other via the wall portion 18D, there is an increase in thermal resistance between the panel guide 18 and the heat dissipation plate 40.

Further, formed between the heat dissipation plate 40 and the panel guide 18 (portions excluding the line contact portion) is the air layer 10C, which is higher in thermal resistance. In particular, the air layer 10C has an enclosed structure so that air convection hardly occurs. This causes a further increase in thermal resistance between the panel guide 18 and the heat dissipation plate 40. For this reason, most of the heat transmitted to the heat dissipation plate 40 is transmitted to the backlight chassis 36, and the amount of heat that is transmitted to the panel guide 18 is small.

(4) The slight amount of heat transmitted to the panel guide 18 is transmitted to the frame 14 (i.e. to the front surface side of the display device 10), which is in contact with the panel guide 18. However, since the panel guide 18 and the frame 14 is in line contact with each other via the wall portions 18A to C, there is an increase in thermal resistance between the panel guide 18 and the frame 14.

Further, formed between the panel guide 18 and the frame 14 (portions excluding the line contact portion) are the air layers 10A and 10B, which are higher in thermal resistance. In particular, each of the air layers 10A and 10B has an enclosed structure so that air convection hardly occurs. This causes a further increase in thermal resistance between the panel guide 18 and the frame 14. For this reason, the amount of heat that is transmitted to the frame 14 is smaller.

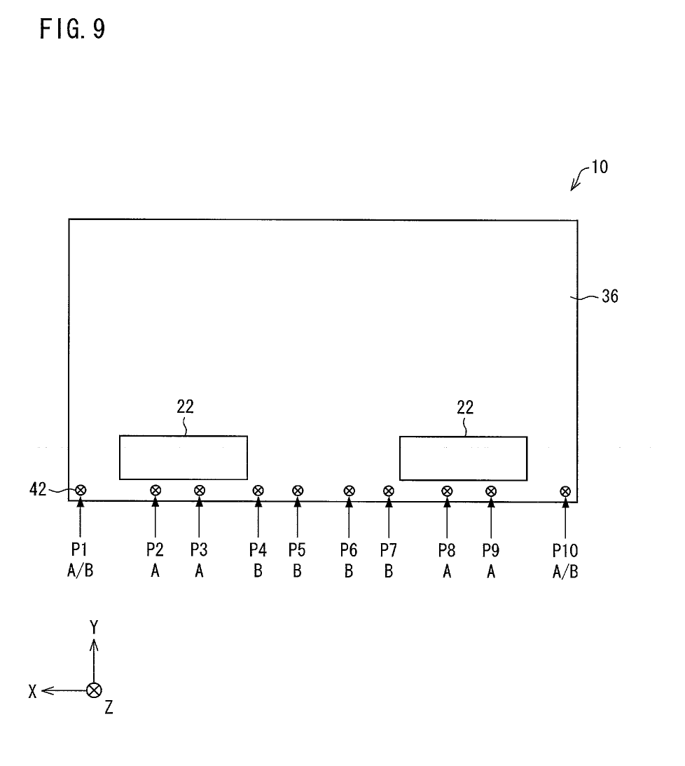

FIG. 9 is a diagram schematically showing fastening positions in the display device 10 according to the present embodiment where the frame 14 and the backlight chassis 36 are fastened together. FIG. 9 shows the back surface side of the display device 10, and the arrows in FIG. 9 indicates fastening positions where the backlight chassis 36 is fastened by the screws 42. Further, the signs A and B beside the arrows indicate to which component the backlight chassis 36 is fastened. FIG. 9 illustrates only those fastening positions on the lower side of the backlight chassis 36 and, for convenience, omits to illustrate the other fastening positions.

For example, those fastening positions marked with the sign A are fastening positions where the backlight chassis 36 is fastened to the frame 14 by screws 42, and those fastening positions marked with the sign B are fastening positions where the backlight chassis 36 is fastened to the heat dissipation plate 40 by screws 42. Further, those fastening positions marked with the sign “A/B” are positions where the backlight chassis 36 may be fastened to the frame 14 or the heat dissipation plate 40.

In the display device 10 of the present embodiment, the conductivity of the heat generated in the LED substrate 34 to the frame 14 is varied by fastening the backlight chassis 36 to different components with screws 42 at a plurality of fastening positions on a long side of the display device 10.

For example, in those places (first and third positions) on the backlight chassis 36 where the transmission of heat to the frame 14 should be minimized, the backlight chassis 36 is fastened to the heat dissipation plate 40 by screws 42 as shown in FIG. 3, and in those places (second and fourth positions) on the backlight chassis 36 where the transmission of heat to the backlight chassis 36 should be minimized, the backlight chassis 36 is fastened to the frame 14 by screws 42 as shown in FIG. 2.

In the example shown in FIG. 9, in each of the positions P4 to P7 near the center of the frame 14, the backlight chassis 36 is fastened to the heat dissipation plate 40 by screws 42, so that the transmission of heat to the frame 14 is minimized. This is intended to minimize the temperature in a position close to the center, as the temperature tends to be higher with decreasing distance from the center.

Meanwhile, in each of those positions P2, P3, P8, and P9 near the speakers 22, the backlight chassis 36 is fastened to the frame 14 by screws 42, so that the transmission of heat to the speakers 22 is minimized. This is intended to minimize the temperature of the speakers 22, as the speakers 22 utilize magnetic forces and therefore are easily influenced by heat.

While, in the above example, the conductivity of heat to the frame 14 is varied by fastening the backlight chassis 36 to different components, this may alternatively be achieved by another method.

For example, this may be achieved by varying the volume of a space between the frame 14 and the panel guide 18, varying the area of contact between the frame 14 and the panel guide 18, or varying the positions of the bosses 15 or the intervals at which the bosses 15 are placed.

For example, in those places (first and third positions) on the backlight chassis 36 where the transmission of heat to the frame 14 should be minimized, the volume may be increased, the area of contact may be narrowed, or the intervals may be widened, and in those places (second and fourth positions) on the backlight chassis 36 where the transmission of heat to the backlight chassis 36 should be minimized, the volume may be reduced, the area of contact may be widened, or the intervals may be narrowed.

### Example

The embodiment of the present invention is described in more detail with reference to Example shown below. Of course, the present invention is not to be limited to this example, and details of the present invention may be in various aspects.

(Outline of the Example)

In the present example, the effectiveness of the present invention was confirmed by preparing a plurality of display devices with different countermeasures against heat through improvements in the display device 10 described in the embodiment and performing temperature measurements at each location of measurement in each display device.

(Locations of Measurement)

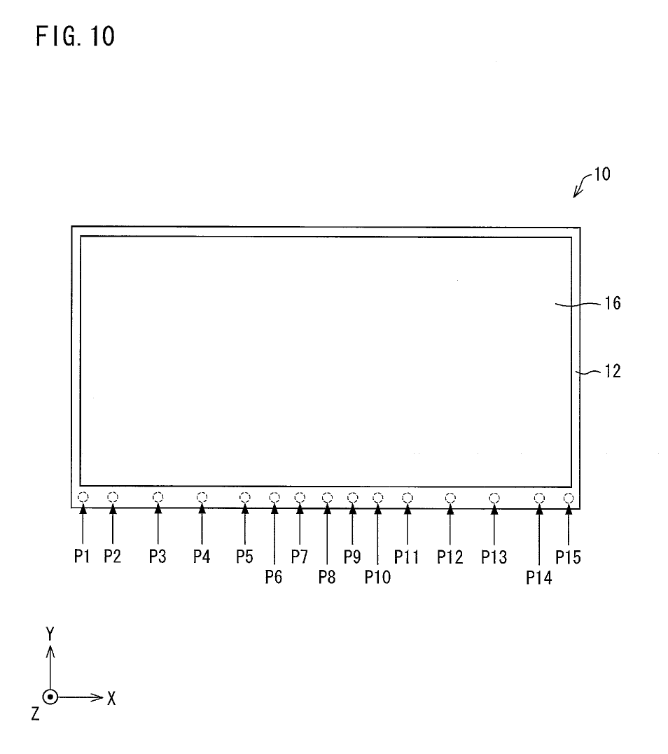

In the present example, the positions P1 to P15 shown in FIG. 10 are locations of measurement. FIG. 10 is a diagram schematically showing locations of measurement in a display device 10 according to the present example. FIG. 10 shows the front surface side of the display device 10, and P1 to P15 indicated by broken circles indicate the locations of measurement in the present example. Further, at each of the locations of measurement, the temperature of the frame 14 was measured.

(Countermeasures Against Heat)

In the present example, a plurality of display devices were prepared which were different from each other in terms of whether or not they were provided with a combination of the following countermeasures A to C against heat.

Countermeasure A: Change the thickness of the backlight chassis 36 from 1.0 mm to 1.5 mm.

Countermeasure B: Change from fastening the backlight chassis 36 to the frame 14 with screws 42 at six fastening positions (P1, P4, P6, P10, P12, and P15) to fastening the backlight chassis 36 to the heat dissipation plate 40 with the screws 42 at the six fastening positions.

Countermeasure C: As shown in FIG. 3, provide a space between the panel guide 18 and the frame 14 by performing thinning processing (referred to also as “lightening processing”) on the contact surface of the panel guide 18 with the frame 14. At the same time, paste a sheet (insulating material) on the contact surface between each of the bosses 15 and the backlight chassis 36 on the frame 14.

(Countermeasures of Each Display Device Against Heat)

In the present example, display devices (1) and (2) were prepared. The display devices (1) and (2) were different from each other in terms of whether or not they were provided with a combination of the countermeasures A to C against heat. The following shows which of the countermeasures against heat the display devices (1) and (2) were each provided. The display devices (1) and (2) are shown in this order with indications as to whether or not they were provided with the countermeasure A against heat, whether or not they were provided with the countermeasure B against heat, and whether or not they are provided with the countermeasure C against heat.

Display device (1): “Not provided with A, Not provided with B, Not provided with C”

Display device (2): “Provided with A, Provided with B, Provided with C”.

(Other Measurement Conditions)

In the present example, measurements were performed on each display device under the following common conditions:

Dynamic/active contrast: “Not Applied”

Image that is displayed: Totally white image.

(Measurement Results Etc.)

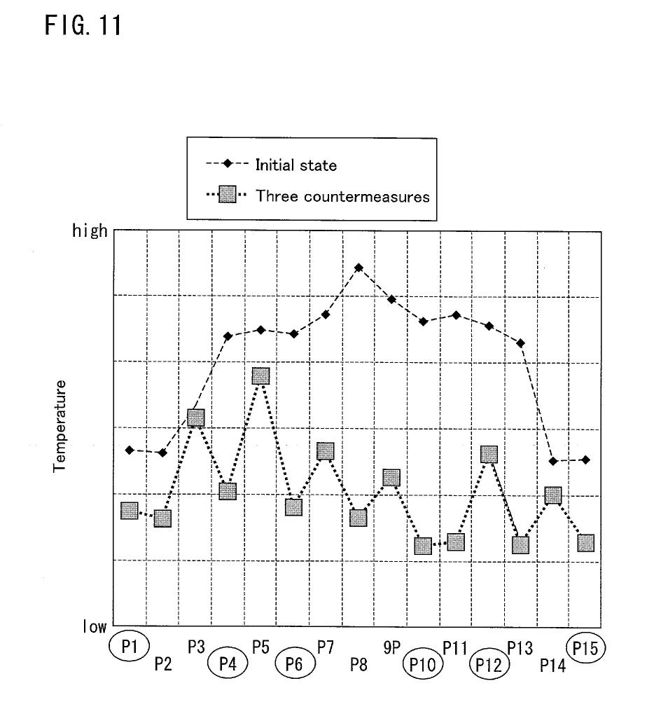

Results of measurement of each display device are shown in FIG. 11. FIG. 11 shows results of measurement by a display device 10 according to the present example. That is, FIG. 11 is a graph showing results of measurement of each of the display devices (1) and (2).

From the results of measurement, it was found that the provision of a space between the frame 14 and the panel guide 18 (i.e. the countermeasure C) can make the temperature of the frame 14 lower than does the configuration provided with no such space. For example, as shown in FIG. 11, whereas the temperature of the frame 14 at the position P8 in the display device (1) provided with no such space is higher, the temperature of the frame 14 at the position P8 in the display device (2) provided with such a space is lower. This achieves an obvious decrease in temperature. Therefore, the configuration of “providing a space between the frame and the panel guide” of the present invention was found to be a very effective configuration so that it dissipates heat generated in the backlight source to the back surface side of the display device and makes it difficult for the heat to be transmitted to the front surface side of the display device.

Further, from the results of measurement, it was found that the temperature of the frame 14 can be lowered by changing from fastening the backlight chassis 36 to the frame 14 with screws 42 to fastening the backlight chassis 36 to the heat dissipation plate 40 with the screws 42. On the other hand, it was found that the temperature of the backlight chassis 36 can be lowered by changing from fastening the backlight chassis 36 to the heat dissipation plate 40 with the screws 42 to fastening the backlight chassis 36 to the frame 14 with the screws 42. Therefore, the configuration of “changing from fastening the backlight chassis 36 to one of the components to fastening the backlight chassis 36 to the other component at a plurality of positions on a long side of the display device 10” of the present invention was found to be a very effective configuration so that it achieves separate temperature adjustments at the respective positions in consideration of the influence of heat on the peripheral components (such as the speakers and an electronic circuit).

(Supplementary Explanation)

The embodiments of the present invention have been described above; however, the present invention is not limited to the description of the embodiments above, but may be altered by a skilled person within the scope of the claims. An embodiment based on a proper combination of technical means disclosed in different embodiments is encompassed in the technical scope of the present invention.

The embodiment has been described by taking, as an example, a case where the present invention is applied to a television receiver. However, the present invention is not limited to such an example. For example, the present invention can be applied to single displays and various types of display device, as well as television receivers.

The embodiment uses bosses as examples of fixed shafts, and uses screws and bosses as examples of fixing pieces. However, the present invention is not limited to such an example. For example, the present invention may use any fixed shafts and fixing pieces that can be fastened to each other.

The embodiment uses LEDs as the backlight source. However, the present invention may use any backlight source whose backlight can enter a backlight panel through a side part of the backlight panel.

### SUMMARY

A display device (display device 10) according to the present invention includes: a display panel (display panel 16); a backlight panel (backlight panel 32) that guides backlight from a back surface of the display panel to the display panel; a backlight source (LED array 35) that illuminates an inner part of the backlight panel with the backlight; a frame (frame 14) that supports the display panel by a front surface side of the display panel; a backlight chassis (backlight chassis 36) that supports the backlight panel by a back surface side of the backlight panel; a heat dissipation plate (heat dissipation plate 40) in contact with a substrate (LED substrate 34) of the backlight source and the backlight chassis, for dissipating heat of the backlight source to the backlight chassis; and a panel guide (panel guide 18), sandwiched between the frame and the backlight chassis, which supports the display panel, the panel guide having a first wall portion (wall portions 18A, 18B, and 18C) standing face to face with the frame, and by the first wall portion having its top in contact with the frame, the panel guide being supported by the frame and forming a space (spaces 10A and 10B) between the panel guide and the frame.

In the display device, the provision of the heat dissipation plate makes it possible to actively dissipate the heat generated by the backlight source to the backlight chassis (i.e. to the back surface side of the display device). Further, the panel guide sandwiched between the backlight chassis and the frame makes it possible to restrain the heat transmitted to the backlight chassis from being transmitted to the frame (i.e. to the front surface side of the display device).

Furthermore, the space formed between the panel guide and the frame brings about a heat insulating effect that makes it possible to restrain the heat transmitted to the backlight chassis from being transmitted to the front surface side of the display device.

This allows most of the heat generated by the backlight source to be dissipated on the back surface side of the display device, thus making it possible to suppress a rise in temperature of the front surface of the display device with a comparatively simple configuration. Therefore, the display device can be said to be a display device that, while reducing costs that are incurred, can appropriately dissipate the heat of the backlight source.

The display device is preferably configured such that the panel guide has a second wall portion standing face to face with the backlight chassis, and by the second wall portion having its top in contact with the backlight chassis, the panel guide is supported by the backlight chassis and forms a space between the panel guide and the backlight chassis.

In the foregoing configuration, the space formed between the panel guide and the backlight chassis brings about a heat insulating effect that makes it possible to restrain the heat transmitted to the backlight chassis from being transmitted to the front surface side of the display device.

Further, the display device is preferably configured such that the panel guide is made of resin.

In the foregoing configuration, the panel guide has such a low thermal conductivity as to make it possible to restrict the heat transmitted to the backlight chassis from being transmitted to the front surface side of the display device.

The display device is preferably configured such that: the frame has fixed shafts to which fixing pieces are coupled, the fixed shafts being fixedly provided on a side of the frame that faces the backlight chassis; the backlight chassis has holes formed therein, and is fastened to the frame by the fixing pieces and the fixing pieces being coupled to each other with the fixing pieces passing through the holes; and the heat dissipation plate has a third wall portion on a side of the backlight chassis that faces the frame, the third wall portion overlapping the backlight chassis, the third wall portion having through-holes formed therein through which the fixed shafts pass.

In the foregoing configuration, the coupling of the frame and the backlight chassis with the heat dissipation plate sandwiched therebetween makes it possible to ensure a large area of contact between the heat dissipation plate and the backlight chassis with a compact configuration and, moreover, makes it possible to restrict the heat transmitted to the heat dissipation plate from being transmitted to the front surface side of the display device via the fixing pieces.

Further, the display device is preferably configured such that the fixed shafts are not in internal contact with the through-holes.

The foregoing configuration causes air layers formed between the fixed shafts and the through-holes, thus making it possible to restrain the heat transmitted to the heat dissipation plate from being transmitted to the front surface side of the display device via the fixing pieces.

Further, the display device is preferably configured such that the backlight chassis is fastened to the heat dissipation plate by a fixing piece at a first position on a long side of the backlight chassis where the heat of the backlight source is desired to be dissipated toward the backlight chassis, and the backlight chassis is fastened to the frame by a fixing piece at a second position on a long side of the backlight chassis where the heat of the backlight source is desired to be dissipated toward the frame.

The foregoing configuration changes, in consideration of the influence of heat on nearby components, components to which the fixing pieces are fastened, thus making it possible to easily and flexibly switch between dissipating the heat of the backlight source toward the frame and dissipating the heat of the backlight source toward the backlight.

Further, the display device is preferably configured such that the backlight chassis and the frame form a space therebetween whose volume is larger in a third position on a long side of the backlight chassis where the heat of the backlight source is desired to be dissipated toward the backlight chassis than in a fourth position on a long side of the backlight chassis where the heat of the backlight source is desired to be dissipated toward the frame.

The foregoing configuration changes, in consideration of the influence of heat on nearby components, the volume of a space that is formed between the backlight chassis and the frame, thus making it possible to easily and flexibly switch between dissipating the heat of the backlight source toward the frame and dissipating the heat of the backlight source toward the backlight.

Further, the display device is preferably configured to further include speakers disposed symmetrically on a long side of the backlight chassis, wherein: the first position or the third position is a position that is near a center of the long side; and the second position or the fourth position is a position that is near either of the speakers on the long side.

By changing components to which the fixing pieces are fastened or the volume of a space that is formed between the backlight chassis and the frame, the foregoing configuration make it possible to simultaneously obtain an effect of suppressing a rise in temperature in the center of the front surface side of the display device and an effect of suppressing the influence of heat on the speakers disposed on the back surface side of the display device.

Further, a television receiver according to the present embodiment includes the display device.

This television receiver can provide a television receiver that brings about the same effects as the display device.

### INDUSTRIAL APPLICABILITY

A display device according to the present invention is applicable to a display device such as a television receiver and a monitor for use in a personal computer and, in particular, is suitably applicable to a thin display device including a backlight panel.

### REFERENCE SIGNS LIST

10 Display device (television receiver)
10A to C Space
12 Bezel
14 Frame
15 Boss (fixed shaft)
16 Display panel
18 Panel Guide
18A to C Wall portion (first wall portion)
18D Wall portion (second wall portion)
20 Sheets
30 Backlight unit
32 Backlight panel
34 LED substrate (substrate of backlight source)
35 LED array (backlight source)
36 Backlight chassis
36A Hole
40 Heat dissipation plate
40A Through-hole
42 Screw (fixing piece)

1-9. (canceled)

10. A display device comprising:
a display panel;
a backlight panel that guides backlight from a back surface of the display panel to the display panel;
a backlight source that illuminates an inner part of the backlight panel with the backlight;
a frame that supports the display panel by a front surface side of the display panel;
a backlight chassis that supports the backlight panel by a back surface side of the backlight panel;
a heat dissipation plate in contact with a substrate of the backlight source and the backlight chassis, for dissipating heat of the backlight source to the backlight chassis; and
a panel guide, sandwiched between the frame and the backlight chassis, which supports the display panel,
the panel guide having a first wall portion standing face to face with the frame, and by the first wall portion having its top in contact with the frame, the panel guide being supported by the frame and forming a space between the panel guide and the frame,
the panel guide having a second wall portion standing face to face with the backlight chassis, and by the second wall portion having its top in contact with the backlight chassis, the panel guide being supported by the backlight chassis.

11. The display device as set forth in claim 10, wherein the panel guide is made of resin.

12. A display device comprising:
a display panel;
a backlight panel that guides backlight from a back surface of the display panel to the display panel;
a backlight source that illuminates an inner part of the backlight panel with the backlight;
a frame that supports the display panel by a front surface side of the display panel;
a backlight chassis that supports the backlight panel by a back surface side of the backlight panel;
a heat dissipation plate in contact with a substrate of the backlight source and the backlight chassis, for dissipating heat of the backlight source to the backlight chassis; and
a panel guide, sandwiched between the frame and the backlight chassis, which supports the display panel,
the panel guide having a first wall portion standing face to face with the frame, and by the first wall portion having its top in contact with the frame, the panel guide being supported by the frame and forming a space between the panel guide and the frame,
the frame having fixed shafts to which fixing pieces are coupled, the fixed shafts being fixedly provided on a side of the frame that faces the backlight chassis;
the backlight chassis having holes formed therein, and being fastened to the frame by the fixing pieces and the fixed shafts being coupled to each other with the fixing pieces passing through the holes; and
the heat dissipation plate having a third wall portion on a side of the backlight chassis that faces the frame, the third wall portion overlapping the backlight chassis, the third wall portion having through-holes formed therein through which the fixed shafts pass.

13. The display device as set forth in claim 12, wherein the fixed shafts are not in internal contact with the through-holes.

14. The display device as set forth in claim 12, wherein the backlight chassis is fastened to the heat dissipation plate by a fixing piece at a first position on a long side of the backlight chassis where the heat of the backlight source is desired to be dissipated toward the backlight chassis, and the backlight chassis is fastened to the frame by a fixing piece at a second position on a long side of the backlight chassis where the heat of the backlight source is desired to be dissipated toward the frame.

15. The display device as set forth in claim 12, wherein the backlight chassis and the frame form a space therebetween whose volume is larger in a third position on a long side of the backlight chassis where the heat of the backlight source is desired to be dissipated toward the backlight chassis than in a fourth position on a long side of the backlight chassis where the heat of the backlight source is desired to be dissipated toward the frame.

16. The display device as set forth in claim 14, further comprising speakers disposed symmetrically on a long side of the backlight chassis, wherein:
the first position or the third position is a position that is near a center of the long side; and
the second position or the fourth position is a position that is near either of the speakers on the long side.

17. A television receiver comprising a display device as set forth in claim 10.

18. A display device comprising:
a display panel;
a backlight panel that guides backlight from a back surface of the display panel to the display panel;
a backlight source that illuminates an inner part of the backlight panel with the backlight;
a frame that supports the display panel by a front surface side of the display panel;
a backlight chassis that supports the backlight panel by a back surface side of the backlight panel;
a heat dissipation plate in contact with a substrate of the backlight source and the backlight chassis, for dissipating heat of the backlight source to the backlight chassis; and
a panel guide, sandwiched between the frame and the backlight chassis, which supports the display panel,
the frame having fixed shafts to which fixing pieces are coupled, the fixed shafts being fixedly provided on a side of the frame that faces the backlight chassis;
the backlight chassis having holes formed therein, and being fastened to the frame by the fixing pieces and the fixed shafts being coupled to each other with the fixing pieces passing through the holes; and
the heat dissipation plate having a third wall portion on a side of the backlight chassis that faces the frame, the third wall portion overlapping the backlight chassis, the third wall portion having through-holes formed therein through which the fixed shafts pass.

19. The display device as set forth in claim 18, wherein the fixed shafts are not in internal contact with the through-holes.

20. The display device as set forth in claim 18, wherein the backlight chassis is fastened to the heat dissipation plate by a fixing piece at a first position on a long side of the backlight chassis where the heat of the backlight source is desired to be dissipated toward the backlight chassis, and the backlight chassis is fastened to the frame by a fixing piece at a second position on a long side of the backlight chassis where the heat of the backlight source is desired to be dissipated toward the frame.

21. The display device as set forth in claim 18, wherein the backlight chassis and the frame form a space therebetween whose volume is larger in a third position on a long side of the backlight chassis where the heat of the backlight source is desired to be dissipated toward the backlight chassis than in a fourth position on a long side of the backlight chassis where the heat of the backlight source is desired to be dissipated toward the frame.

22. A television receiver comprising a display device as set forth in claim 18.
